(19) United States
(12) Patent Application Publication
(10) Pub. No.: US 2016/0055252 A1
(43) Pub. Date: Feb. 25, 2016

(54) METHODS AND SYSTEMS FOR PERSONALIZING AGGREGATED SEARCH RESULTS

(71) Applicant: YANDEX EUROPE AG, Luzern (CH)

(72) Inventors: Stanislav Sergeevich MAKEEV, Moscow (RU); Andrey Grigorievich PLAKHOV, Sergiev Posad (RU); Pavel Viktorovich SERDYUKOV, Moscow (RU)

(21) Appl. No.: 14/929,466

(22) Filed: Nov. 2, 2015

Related U.S. Application Data
(63) Continuation of application No. PCT/IB2014/065967, filed on Nov. 11, 2014.

(30) Foreign Application Priority Data
May 7, 2014 (RU) 2014118338

(51) Int. Cl. G06F 17/30

(52) U.S. Cl. CPC G06F 17/30867; G06F 17/30554; G06F 17/3053

(57) ABSTRACT

There are provided methods and systems for presenting a personalized aggregated search results page (SERP) to a user in response to a search query. The method can be executable at a server. The method comprises appreciating a user-specific aggregation preference parameter, the user-specific aggregation preference parameter having been generated based on at least one feature of the user's search history; ranking a first general search result item and a first vertical search result item relative to each other based at least on the user-specific aggregation preference parameter, to generate a ranked order of search results items; and causing an electronic device associated with the user to display the ranked order of search results items within the SERP.

### CROSS-REFERENCE

The present application claims priority to Russian Patent Application No. 2014118338, filed May 7, 2014, entitled “METHODS AND SYSTEMS FOR PERSONALIZING AGGREGATED SEARCH RESULTS” and is a continuation of International Patent Application NO. PCT/IB2014/065967 filed on Nov. 11, 2014, entitled “METHODS AND SYSTEMS FOR PERSONALIZING AGGREGATED SEARCH RESULTS”, the entirety of both of which are incorporated herein by reference.

### FIELD

The present technology relates to search engines in general and specifically to a system and method for personalizing aggregated search results on a search result page.

### BACKGROUND

Various global or local communications networks (the Internet, the World Wide Web, local area networks and the like) offer a user a vast amount of information. The information includes a multitude of contextual topics, such as but not limited to, news and current affairs, maps, company information, financial information and resources, traffic information, games, and entertainment-related information. Users use a variety of client devices (desktop, laptop, notebook, smartphone, tablets, and the like) to have access to rich content (like images, audio, video, animation, and other multimedia content from such networks).

Generally speaking, a given user can access a resource on the communications network by two principle means. The given user can access a particular resource directly, either by typing an address of the resource (typically an URL or Universal Resource Locator, such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

There are numerous search engines available to the user. Some of them are considered to be general purpose search engines (such as Yandex™, Google™, Yahoo™, and the like). Others are considered to be vertical search engines—i.e., search engines dedicated to a particular topic of search—such as Momondo™ search engine dedicated to searching flights.

Irrespective of which search engine is used, the search engine is generally configured to receive a search query from a user, to perform a search and to return a ranked search result page (also referred to as search engine results page, or SERP) to the user. Several attempts have been made to improve the design of the SERP in the aim of enabling the user to more easily and quickly appreciate search results.

In addition to general internet or web searches, search engines often provide access to specialized search services or vertical domains which allow a user to obtain results of a certain media type (e.g., video, images, etc.) or dedicated to a specific domain (e.g., news, weather, etc.). For some search queries, the results of these vertical domains may be integrated into the general search results within a SERP. This method has been widely used in recent years by leading commercial search engines and is usually referred to as an aggregated search. Aggregated searches can provide the user with the opportunity to obtain relevant results of a certain type directly on the SERP.

One of the most important problems regarding aggregated search is the problem of finding verticals relevant to the user's request and placing their results properly on the SERP. Traditionally, this problem has been addressed by training a machine-learned model based on features which supposedly detect the vertical domain's relevance to the query. Examples of such features include: query data (e.g., using the text of the query to determine relevance of a vertical domain); vertical data (e.g., using properties of a vertical domain's indexed documents collection); click-through data (e.g., using the history of the user's search behaviour including clicks, skips, etc.); and Web data (e.g., using features obtained from general web search results such as text-relevance, click-through features of the web documents, etc.).

U.S. Patent Application Publication No. US2013/0067364 discloses methods and systems for facilitating presentation of search result items having varying prominence, where the size of the search result item is adjusted in accordance with the determination that the size prominence of the search result item is to be modified. Displaying search result items with varying degrees or extents of prominence assists in engaging a user in a search result item(s) the user may deem of interest or more relevant. As such, a user may be able to more readily identify or select information that is pertinent to or desired by the user. For instance, a search result item displayed in a greater or more prominent size relative to other search result items is more likely to be recognized by a user.

### SUMMARY

It is an object of the present technology to ameliorate at least some of the inconveniences present in the prior art.

There are provided herein methods and systems for personalizing aggregated search results. In a broad aspect of the present technology, personal relevance of general domain and vertical domain search results is determined for a specific user, and used for aggregating the search results on a search results page (also referred to herein as a search engine results page, or SERP). In some implementations, results from different searches, e.g., from different vertical domain searches, are blended. In some implementations, personal relevance of search results for a specific user is determined using information from the user's search history. In one non-limiting example, described in further detail below, a machine-learned personalized verticals ranking function which significantly improves baseline verticals ranking is used, based on at least one of three classes of personalized features.

According to a broad aspect of the present technology, there is provided a method of presenting a search result page (SERP) to a user in response to a search query, the SERP including a first general search result item (i.e., a search result item from searching a general domain) and a first vertical search result item (i.e., a search result item from searching a vertical domain). The method is executable at a server. The method comprises appreciating a user-specific aggregation preference parameter, the user-specific aggregation preference parameter having been generated based on at least one feature of the user's search history; ranking the first general search result item and the first vertical search result item relative to each other based at least on the user-specific aggregation preference parameter, to generate a ranked order of search results items; and causing an electronic device associated with the user to display the ranked order of search results items within the SERP.

In some implementations, the SERP includes a second vertical search result item; the first general search result item, the first vertical search result item, and the second vertical search result item are ranked relative to each other based at least on the user-specific aggregation preference parameter, to generate a ranked order of search results items; and an electronic device associated with the user is caused to display the ranked order of search results items within the SERP.

In some implementations, the first vertical search result item and the second vertical search result item are ranked together relative to the general search result item and displayed as a block within the SERP. In alternative implementations, the first vertical search result item and the second vertical search result item are ranked and displayed separately within the SERP.

In some implementations, the first vertical search result item and the second vertical search result item are generated by searching the same vertical domain. In other words, the first vertical search result item is generated by searching a first vertical domain, the second vertical search result item is generated by searching a second vertical domain, and the first vertical domain and the second vertical domain are the same. In other implementations, the first vertical search result item and the second vertical search result item are generated by searching different vertical domains, in other words, the first vertical domain and the second vertical domain are not the same.

In some implementations, the SERP includes a second general search result item; the first general search result item, the first vertical search result item, the second vertical search result item, and the second general search result item are ranked relative to each other based at least on the user-specific aggregation preference parameter, to generate the ranked order of search results items; and an electronic device associated with the user is caused to display the ranked order of search results items within the SERP.

In some implementations, the first general search result item is ranked based on a general domain-ranking parameter, before the ranking based at least on the user-specific aggregation preference parameter. In some implementations, the first vertical search result item is ranked based on a vertical domain-ranking parameter, before the ranking based at least on the user-specific aggregation preference parameter.

In some implementations, the first general search result item and the second general search result item are ranked based on a general domain-ranking parameter, before the ranking based at least on the user-specific aggregation preference parameter. In some implementations, the first vertical search result item and the second vertical search result item are ranked based on a vertical domain-ranking parameter, before the ranking based at least on the user-specific aggregation preference parameter.

In some implementations, methods provided herein further comprise a step of determining that the first general search result item, the first vertical search result item, the second vertical search result item, and/or the second general search result item are relevant to the user's search query, prior to the step of ranking the search result items based at least on the user-specific aggregation preference parameter.

In some implementations, any one of the general domain-ranking parameter and the vertical domain-ranking parameter includes a user-specific ranking attribute, i.e., a user-specific general ranking attribute and/or a user-specific vertical ranking attribute, respectively. The user-specific general ranking attribute and the user-specific vertical ranking attribute are based on at least one feature of the user's search history. In some implementations, the at least one feature of the user's search history on which the user-specific general ranking attribute and/or the user-specific vertical ranking attribute is based is the same as the at least one feature of the user's search history on which the user-specific aggregation preference parameter is based. In other implementations, the at least one feature of the user's search history on which the user-specific general ranking attribute and/or the user-specific vertical ranking attribute is based is different from the at least one feature of the user's search history on which the user-specific aggregation preference parameter is based.

In some implementations, the at least one feature of the user's search history includes at least one of: user's past preference for aggregated general content and vertical content, general content alone, or vertical content alone; user's past preference for obtaining results from a specific vertical domain; and user's intent for the search query. User's intent may include, for example, intent for a particular type of vertical content (i.e., vertical domain content, or content identified by searching a vertical domain) Examples of particular types of vertical content include, without limitation, video content, image content, commerce content, music content, weather content, geographic content, text content, dictionary content, events content, news content, and advertising content.

In some implementations, the at least one feature of the user's search history includes at least one of: a click-through rate; a number of times a search result item was selected or clicked within a particular time period; a dwell-time after clicking; and whether a click on a result item was the last user action in a previous user session.

In some implementations, the at least one feature of the user's search history includes any one of query data; vertical data; web data; and search-log data.

In some implementations, the at least one feature of the user's search history includes any one of aggregated search need; certain vertical preference; and vertical navigationality.

In some implementations, the user-specific aggregation preference parameter is generated using a Gradient Boosted Decision Tree-based algorithm. In some implementations, the user-specific aggregation preference parameter is generated using a machine learning algorithm. The user-specific aggregation preference parameter may have been generated prior to a point of time when the user has submitted the search query; at the point of time when the user submits the search query; or after a point of time when the user submitted the search query.

In some implementations, appreciating a user-specific aggregation preference parameter comprises accessing a log, the log including at least one feature of the user's search history. The log may be stored in association with the user's log-in credentials.

In accordance with another broad aspect of the present technology, there is provided a server configured for presenting a search result page (SERP) to a user in response to a search query, the server having a transient computer usable information storage medium that stores computer executable instructions, which instructions when executed are configured to render the server operable to execute the steps of: appreciating a user-specific aggregation preference parameter, the user-specific aggregation preference parameter being generated based on at least one feature of the user's search history; ranking a first general search result item and a first vertical search result item relative to each other based at least on the user-specific aggregation preference parameter, to generate a ranked order of search results items; and causing an electronic device associated with the user to display the ranked order of search results items within a search results page (SERP) in response to the search query.

In accordance with yet another broad aspect of the present technology, there is provided a non-transitory computer readable storage medium storing instructions, which when executed by at least one processor causes performance of: presenting a search result page (SERP) to a user in response to a search query, the presenting a SERP to the user comprising: appreciating a user-specific aggregation preference parameter, the user-specific aggregation preference parameter having been generated based on at least one feature of the user's search history; ranking a first general search result item and a first vertical search result item relative to each other based at least on the user-specific aggregation preference parameter, to generate a ranked order of search results items; and causing an electronic device associated with the user to display the ranked order of search results items within the SERP.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device associated with the user” is any computer hardware that is capable of running software appropriate to the relevant task at hand. Thus, some (non-limiting) examples of electronic devices associated with users include personal computers (desktops, laptops, netbooks, etc.), smartphones, and tablets, as well as network equipment such as routers, switches, and gateways. It should be noted that a device acting as an electronic device associated with the user in the present context is not precluded from acting as a server to other user-associated electronic devices. The use of the expression “an electronic device associated with the user” does not preclude multiple electronic devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations, etc.), data (location data, numerical data, etc.), text (opinions, comments, questions, messages, etc.), documents, spreadsheets, etc.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the expression “search result item” is intended to include a component on a search results page (i.e., SERP) that is displayed in response to a user search query. By way of example only, a component can be, for instance, a web result, an instant answer, a related search result, an advertisement, a tab item, or the like. In one embodiment, for example, a search result item can be a web result, an instant answer, a related search result, an advertisement, a tab item, or the like. Additionally or alternatively, a search result item can be a set of components displayed as a group adjacent to one another on a search results page. For example, a search result item can be a group of images that are positioned adjacent to one another such that the group appears as one search result item. For example, with reference to FIG. 1, vertical search result item 106 is a group of images positioned side-by-side including image component 122, image component 124, and image component 126.

In the context of the present specification, the expression “query” is intended to include any type of request including one or more search terms that can be submitted to a search engine (or multiple search engines) for identifying search result items, and/or component(s) thereof, based on the search term(s) contained in the query. The search result items or components thereof that are identified by the queries in the data structure are representations of results produced in response to the queries. For example, the search result items can be web results, instant answers, etc.

In the context of the present specification, a “block” is intended to include a short sequence of Web (general) or same-vertical results which are presented grouped together in a SERP. A block may be grouped together vertically (e.g., news) or horizontally (e.g., images) in a SERP.

In the context of the present specification, the expression “general domain” is intended to include general content, for example, indexed internet content or web content. For example, a general domain search is not confined to search a specific category of results but is able to provide all results that best match the query. Such a general (category-independent) search by a search engine may return search results that include non-category specific digital content as well as category specific digital content, such as images, videos, news, shopping, blogs, books, places, discussions, recipes, patents, stocks, timelines, etc., and other digital content that is closely related and directed toward a certain type of digital content. As an example, a general domain search may be a WWW search. A search performed in a general domain generates a “general search result” or “general search result item.” Such general search results are also referred to herein as “web results,” “web search results,” “core web results,” and “common web results.” Typically, a web result includes a website link and a snippet that summarizes content of the website. A user may select a website link of a web result to navigate to the webpage related to the user search query.

In the context of the present specification, the expression “vertical domain” is intended to include an information domain containing specialized content, such as content of a single type (e.g., media type, genre of content, topicality, etc.). A vertical domain thus includes a specific subset of a larger set of data, for example, a specific subset of web data. For example, a vertical domain may include specific information such as news, images, videos, local businesses, items for sale, weather forecasts, etc. A search performed in a vertical domain generates a “vertical search result” or a “vertical search result item.” Such vertical search results are also referred to herein as “verticals” and “vertical results.”

In the context of the present specification, the expression “aggregated search result” is intended to include integrating general (e.g., Web) search results and vertical search results together within a search results page. For example, vertical search results may be integrated into general (e.g., Web) search results within a search results page, or vice-versa, i.e., general search results may be integrated into vertical search results within a search results page.

In the context of the present specification, the expression “user-specific aggregation preference parameter” is intended to include a ranking tool that is based on at least one feature of the user's search history and is used to rank aggregated search results. Generally, the user's search history provides historical data or information (referred to herein as “features”) pertaining to a query or a resulting search result item or component thereof. These features of the user's search history may describe or characterize a query, a search result item, and/or user engagement or interaction therewith. User engagement or interaction generally refers to a user engaging or interacting (e.g., selecting, clicking, etc.) with a search result item. Thus a feature of the user's search history may be, for example, a number of times a search result item has been presented (e.g., within a particular time frame), a placement or position of a search result item, a number of times a search result item is selected or clicked (e.g., within a particular time period), a click-through rate, a number of times a search result item is selected at a particular position or size within a SERP (e.g., within a particular time frame), a designation or classification as to query intent (i.e., whether a query includes a particular intent, such as video intent, image intent, commerce intent), and the like. It should be appreciated that such features of the user's search history can be updated or modified as historical data is gathered. Accordingly, as more data is monitored and analyzed, more recent data can be used to generate new or modified features of the user's search history.

In some implementations, aggregated search results items (i.e., general search results items and vertical search results items) are ranked relative to each other according to a user-specific aggregation parameter, which is appreciated using at least one feature of the user's search history. A user-specific aggregation parameter can be based on any feature or combination of features of the user's search history as described above, such as, for example, click-through rates in query logs, navigation history, search history, and the like. As such, features can be analyzed to determine where search result items, or components thereof, should be placed within a search results page in accordance with the user's needs or preferences. Search result items most relevant to a particular query are generally provided with a higher ranking, i.e., a rank that is stronger or otherwise indicates a higher priority or preference.

In some implementations, general search results are first ranked based on a general domain-ranking parameter, before being aggregated with vertical search results and subsequently ranked according to the user-specific aggregation parameter. In the context of the present specification, the expression “general domain-ranking parameter” is intended to include a ranking tool that is used to rank general search results items. Many such ranking tools are known and it should be understood that any such tools may be used in methods and systems provided herein. In one implementation, a general domain-ranking parameter is based on or includes at least one user-specific general ranking attribute. As used herein, the expression “user-specific general ranking attribute” is intended to include any feature or combination of features of the user's search history pertaining to general search results, such as, for example, click-through rates in query logs, navigation history, search history, and the like, that can be analyzed to determine where general search result items, or components thereof, should be placed within a general search results page in accordance with the user's needs or preferences.

Similarly, in some implementations, vertical search results are first ranked based on a vertical domain-ranking parameter, before being aggregated with general search results and subsequently ranked according to the user-specific aggregation parameter. In the context of the present specification, the expression “vertical domain-ranking parameter” is intended to include a ranking tool that is used to rank vertical search results items. Many such ranking tools are known and it should be understood that any such tools may be used in methods and systems provided herein. In one implementation, a vertical domain-ranking parameter is based on or includes at least one user-specific vertical ranking attribute. As used herein, the expression “user-specific vertical ranking attribute” is intended to include any feature or combination of features of the user's search history pertaining to vertical search results, such as, for example, click-through rates in query logs, navigation history, search history, and the like, that can be analyzed to determine where vertical search result items, or components thereof, should be placed within a vertical search results page in accordance with the user's needs or preferences.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a screenshot 100, the screenshot 100 depicting a SERP implemented in accordance with known techniques, the SERP showing aggregated vertical search results (video, images) and general search results.

FIG. 2 depicts a graph showing Mean Average Precision (MAP) change as a function of adapted click entropy.

FIG. 3 depicts a graph showing distribution of MAP change for unique queries, ordered by MAP change.

FIG. 4 depicts a graph showing distribution of MAP change for users, ordered by MAP change.

FIG. 5 depicts a graph showing MAP change for user buckets.

FIG. 6 is a schematic diagram depicting a method 600, the method 600 being implemented in accordance with non-limiting embodiments of the present technology.

FIG. 7 is a schematic diagram depicting a method 700, the method 700 being implemented in accordance with non-limiting embodiments of the present technology.

FIG. 8 is a schematic diagram depicting a method 800, the method 800 being implemented in accordance with non-limiting embodiments of the present technology.

FIG. 9 is a schematic diagram depicting a system 900, the system 900 being implemented in accordance with non-limiting embodiments of the present technology.

### DETAILED DESCRIPTION

The description that follows is intended to be only a description of illustrative examples of the present technology. This description is not intended to define the scope or set forth the bounds of the present technology. In some cases, what are believed to be helpful examples of the methods and systems provided herein may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the methods and systems described herein may provide in certain instances simple implementations of the present technology, and that where such is the case they have been presented in this manner as an aid to understanding. As persons skilled in the art would understand, various implementations of the present technology may be of a greater complexity.

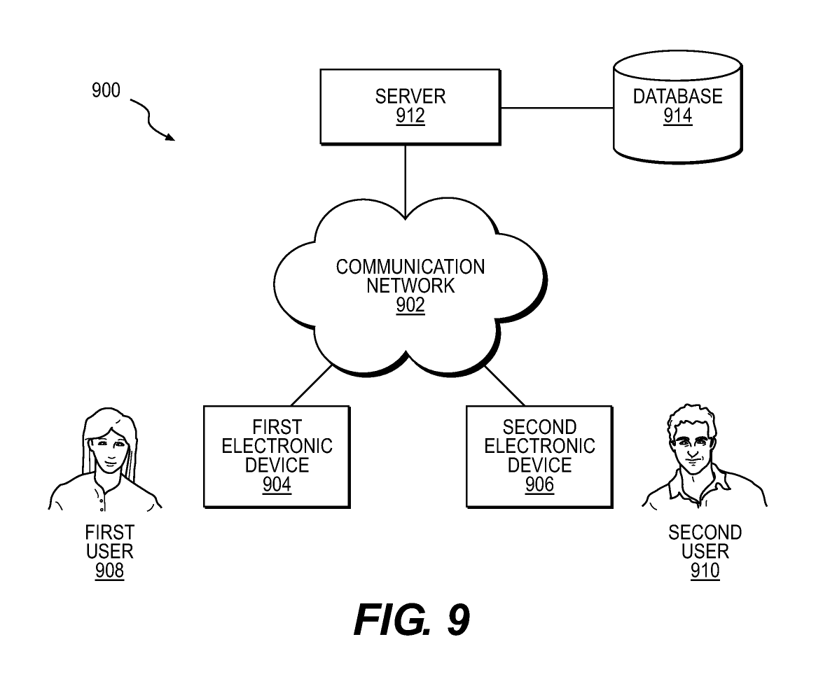

Referring to FIG. 9, there is shown a schematic diagram of a system 900, the system 900 being suitable for implementing non-limiting embodiments of the present technology. It is to be expressly understood that the system 900 as depicted is merely an illustrative implementation of the present technology. The system 900 comprises a communication network 902. The communication network 902 is typically associated with a plurality of electronic devices associated respectively with a plurality of users. A first electronic device 904 and a second electronic device 906 are indicated in the figure for illustrative purposes. First electronic device 904 is associated with a first user 908. Second electronic device 906 is associated with a second user 910. It should be noted that the fact that the client devices are associated with specific users does not need to suggest or imply any mode of operation.

The communication network 902 is also associated with a server 912. The server 912 may implement searches, rank search results, aggregate search results, cause electronic devices associated with users to display search results pages, etc. In some implementations, the server 912 may store information and data (e.g., in a database 914), such as user's search histories and features thereof, user-specific aggregation preference parameters, etc.

It should be expressly understood that implementations for electronic devices 904, 906, communication network 902, and server 912 are provided for illustration purposes only. As such, those skilled in the art will easily appreciate other specific implementational details for these elements. As such, examples provided herein above are not meant to limit the scope of the present technology.

Implementation of the server 912 is not particularly limited. As an example, the server 912 may be implemented as a single server or as a plurality of servers. The server 912 can be implemented as a conventional computer server, or in any other suitable hardware and/or software and/or firmware or a combination thereof. The server 912 is capable of receiving requests (e.g., from an electronic device 904 associated with a user 908) over a network (e.g., a communication network 902), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

Implementation of the electronic device 904, 906 associated with the user 908, 910 is not particularly limited. For example, user 908, 910 may operate in various contexts, wherein in each of them the user plays a different role and has different responsibilities. These different roles might relate to the professional or personal life of the user in the role of employee, contractor, customer, supplier, or family member, for example. Within these various contexts, a user may use different electronic devices (e.g., desktop computers, laptop computers, personal computers, mobile phones, tablets, etc.) or electronic devices that utilize remote processing capability (e.g., applications hosted on a web site or a virtual machine hosted in a data center). Different computing environments might be installed on electronic devices with local processing capabilities (e.g., different operating systems, virtual software environments, Web applications, native applications, containers, BIOS/APIs, etc.) to interact with a server. Users use a variety of electronic devices (desktop computers, laptop computers, notebooks, smartphones, tablets, and the like) to have access to content on networks (such as images, audio, video, animation, and other multimedia content). The electronic device 904, 906 comprises hardware and/or software and/or firmware (or a combination thereof), as is known in the art, to execute a search. Generally speaking, a given user 908, 910 can access computing services on a server regardless of predetermined hardware/software systems and communications networks in use.

Generally speaking, the user 908, 910 executes the search by making a search query using a search engine. How the search is implemented is not particularly limited. In one example, a user may access a web site associated with a search engine to make a search query. For example, a search engine can be accessed by typing in an URL associated with the Yandex search engine at www.yandex.ru. It should be expressly understood that the search query can be made, and the search can be executed, using any other commercially available or proprietary search engine. In some non-limiting embodiments of the present technology, the search query may be made using a browser application on a portable device (such as a wireless communication device). For example (but not limited) to those implementations, where the electronic device 904, 906 associated with the user is implemented as a portable device, such as for example, Samsung™ Galaxy™ SIII, the electronic device 904, 906 may be executing a Yandex browser application. It should be expressly understood that any other commercially available or proprietary browser application can be used for implementing non-limiting embodiments of the present technology.

In some non-limiting embodiments of the present technology, the electronic device 904, 906 associated with the user 908, 910 is coupled to a communications network 902, e.g., via a communication link (not depicted). In some non-limiting embodiments of the present technology, the communications network 902 can be implemented as the Internet. In other embodiments of the present technology, the communications network 902 can be implemented differently, such as any wide-area communications network, local-area communications network, a private communications network and the like. How the communication link is implemented is not particularly limited and will depend on how the electronic device 904, 906 is implemented. Merely as an example and not as a limitation, in those embodiments of the present technology where the electronic device 904, 906 is implemented as a wireless communication device (such as a smart-phone), the communication link can be implemented as a wireless communication link (such as but not limited to, a 3G communications network link, a 4G communications network link, a Wireless Fidelity, or WiFi® for short, Bluetooth® and the like). In those examples, where the electronic device 904, 906 is implemented as a notebook computer, the communication link can be either wireless (such as the Wireless Fidelity, or WiFi® for short, Bluetooth® or the like) or wired (such as an Ethernet based connection). Those skilled in the art will easily appreciate that these implementations are given by way of example only and that other implementations details for the electronic device associated with the user, the communication link and the communications network are possible.

In some implementations, the server 912 is also coupled to the communications network 902. As discussed above, the server 912 can be implemented as a conventional computer server. In an example of an embodiment of the present technology, the server 912 can be implemented as a Dell™ PowerEdge™ Server running the Microsoft™ Windows Server™ operating system. The server 912 can be implemented in any other suitable hardware and/or software and/or firmware or a combination thereof. In some implementations, the server 912 is a single server. In alternative non-limiting embodiments of the present technology, the functionality of the server 912 may be distributed and may be implemented via multiple servers.

The server 912 is communicatively coupled (or otherwise has access) to a database 914. The general purpose of the database 914 is store information and data, e.g., features of the search histories for user 908, 910, user-specific aggregation preference parameters for user 908, 910, etc. The implementation of the database 914 is not particularly limited. It should be understood that any suitable hardware for storing data may be used. In some implementations, the database 914 may be physically contiguous with the server 912, i.e., they are not necessarily separate pieces of hardware, as depicted, although they may be.

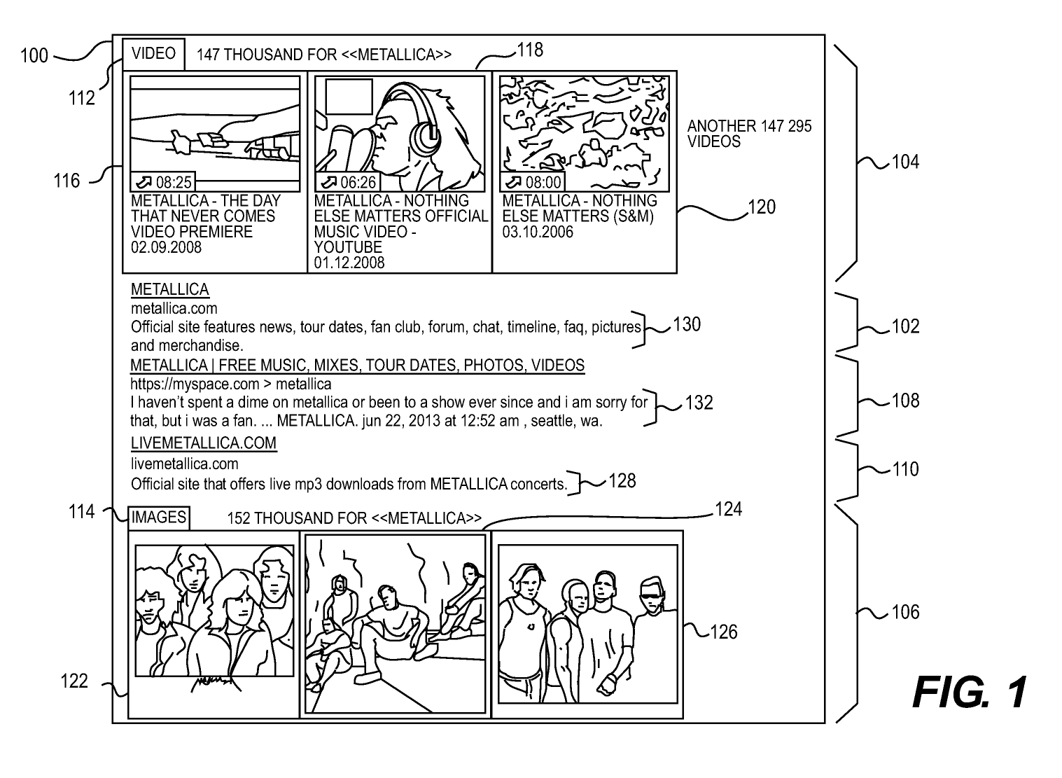

An example of an aggregated search result is shown in FIG. 1, which depicts a screenshot 100, the screenshot 100 depicting a search results page (SERP) produced by a commercial search engine in response to the query “metallica”, and implemented in accordance with known techniques. In the depicted embodiment, the SERP displays aggregated search results including a first vertical search result item 104 (composed of three image components 116, 118, and 120, which are video screenshots) generated by searching a first vertical domain 112; a second vertical search result item 106 (composed of three image components 122, 124, and 126) generated by searching a second vertical domain 114; a first general search result item 102; a second general search result item 108; and a third general search result item 110. First general search result item 102 and third general search result item 110 include a summary of information 130 and 128, respectively. Second general search result item 108 includes a snippet 132, which allows the user to preview content of the second general search result item 108.

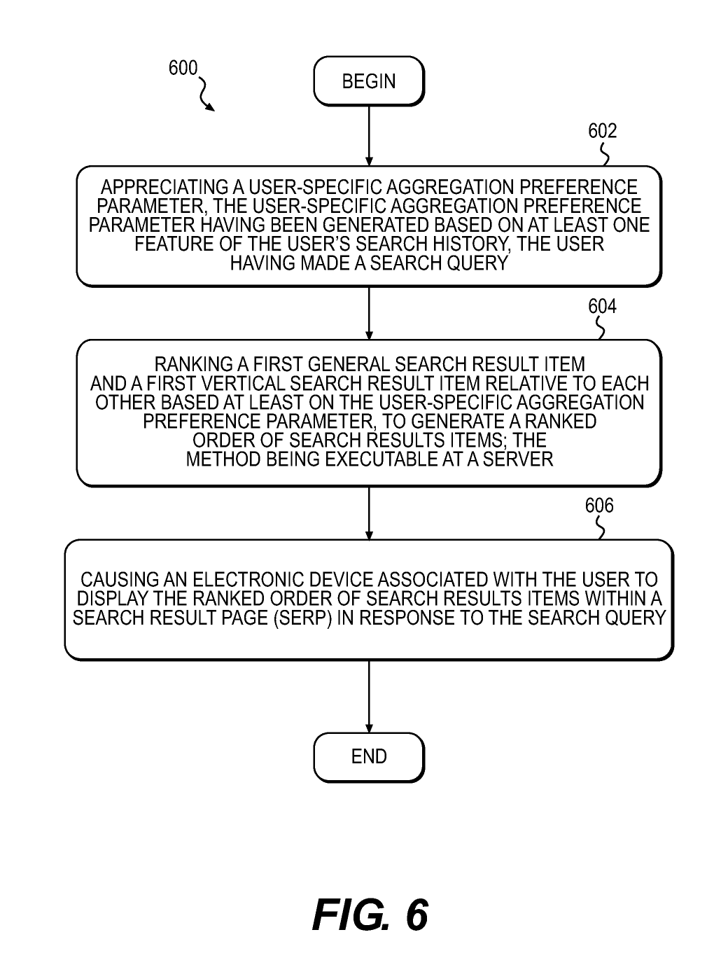

Reference will now be made to FIG. 6, which depicts a block diagram of a method 600, the method 600 being implemented in accordance with non-limiting embodiments of the present technology. The method 600 can be conveniently executed at a server 912.

Step 602—Appreciating a User-Specific Aggregation Preference Parameter

The method 600 begins at step 602, where a server 912 appreciates a user-specific aggregation preference parameter, in response to the user 908, 910 having made a search query, the user-specific aggregation preference parameter having been generated based on at least one feature of the user's search history.

In some non-limiting embodiments of the present technology, an at least one feature of the user's search history is any historical data or information pertaining to previous queries made by the user 908, 910 or resulting search result items or components thereof, such as, but not limited to: description or characterization of a query or a search result item; and user engagement or interaction therewith. User engagement or interaction generally refers to a user engaging or interacting (e.g., selecting, clicking, etc.) with a search result item. Thus, a feature of the user's search history may be a number of times a search result item has been presented (e.g., within a particular time frame), a placement or position of a search result item, a number of times a search result item is selected or clicked (e.g., within a particular time period), a click-through rate, a number of times a search result item is selected at a particular position or size within a SERP (e.g., within a particular time frame), a designation or classification as to query intent (i.e., whether a query includes a particular intent, such as video intent, image intent, commerce intent), and the like. It should be appreciated that such features of the user's search history can be updated or modified as historical data is gathered. Accordingly, as more data is monitored and analyzed, more recent data can be used to generate new or modified features of the user's search history.

In some non-limiting embodiments of the present technology, a feature of the user's search history is any one of query data, vertical data, web data, and search-log data. In some implementations, which are provided here by way of example only, these features may be appreciated as follows:

First, a baseline, user-independent feature vector φ_{B}(q,r) is constructed. The first element of φ_{B}(q,r) is I(r), so that a learning method is always informed of the type of the result (i.e., whether it is a web result, images result, news results, etc.). Features unavailable for a certain result type are set to zero and the first element of φ_{B}(q,r) hence indicates such situations.

Next, to appreciate query data, a boolean variable indicating whether the query is considered to be navigational is included into the baseline feature set. For each vertical Vⱼ there is also built a unigram vertical language model Lⱼ. Each model is built based on the queries for which the result from Vⱼ was clicked with a dwell time of more than, for example, 30 seconds. It should be understood that different dwell times may be used, such as, for example, 10 seconds, 20 seconds, 30 seconds, 40 seconds, 50 seconds, 1 minute, 2 minutes, 3 minutes, etc. In the case where r is a vertical result and I(r)=j, a query likelihood Lⱼ can be added to the feature vector φ_{B}(q,r). In the case where r is a general web result, zero can be appended to φ_{B}(q,r).

To appreciate vertical data and web data, in some implementations, the first feature considered may be the result position in the original ranking. The result relevance score estimated by the original ranking algorithm only for web documents can also be utilized as a feature. It is noted that in this example, the baseline set of features φ_{B}(q,r) includes features needed to produce a non-personalized version of a vertical relevance score.

To appreciate search-log data, in some implementations, click-based features may be used, such as the following non-limiting examples:

$${F}^{c} = \frac{C ( q , • , χ ( r ) )}{S ( q , • , χ ( r ) )} , {F}_{30}^{c} = \frac{{C}_{30} ( q , • , χ ( r ) )}{S ( q , • , χ ( r ) )} , {F}_{100}^{c} = \frac{{C}_{100} ( q , • , χ ( r ) )}{S ( q , • , χ ( r ) )}$$

$${F}_{l , 30}^{c} = \frac{{C}_{l , 30} ( q , • , χ ( r ) )}{S ( q , • , χ ( r ) )} , {F}_{\%}^{c} = \frac{C ( q , • , χ ( r ) )}{C ( q , • , • )}$$

where:

C(q, u, r) is the number of clicks made by user u on specific result item r for query q;

S(q, u, r) is the number of times a result item r was seen by user u following query q;

indicates the sum of all values for the indicated variable during the observed period of time (for example, C(, u, r) is

$${\sum }_{i} C ( {q}_{i} , u , r ) ,$$

where qᵢ are all the queries issued by user u during the observed period of time);

χ(r) is rᵢ if I(rᵢ) is zero, and V_{I(ri)} if I(rᵢ) is not zero;

I(rᵢ) is j if rᵢ is a vertical search result item, and I(rᵢ) is zero if rᵢ is a general search result item;

F^{C} is a feature of the user's search history which is the ratio of number of clicks to the number of times seen for a result item, c indicating that this feature pertains to user's click history;

C₃₀ is the number of clicks with a dwell time of more than 30 seconds; C₁₀₀ is the number of clicks with a dwell time of more than 30 seconds; C_{l,30} is the number of clicks which were the last clicks on the result search items and had a dwell time of more than 30 seconds; and

r is a general search result item or a vertical search result item.

In general, as used herein, if r is a vertical search result item, then χ(r) refers to a block of vertical search result items in the same vertical domain V (V is used herein to refer to a vertical domain). It will be understood therefore that χ(rᵢ) is general search result item rᵢ in the case where r is a general search result item, and χ(rᵢ) is the vertical domain to which rᵢ belongs in the case where r is a vertical search result item. In the case where χ(r) is Vⱼ, such features provide information about clicks on vertical results, and may be considered as vertical data features. When I(r) is zero, this indicates that r is not a vertical search result item, and χ(r) is r.

In some non-limiting implementations of the present technology, a feature of the user's search history is any one of the following three vertical-related features: aggregated search need; certain vertical preference; and vertical navigationality.

In a non-limiting embodiment, “aggregated search need” describes whether the user 908, 910 is interested in aggregated search results in general, and prefers them to general web results. Generally, vertical results are presented differently from general web results, and this presentation may affect the user's experience. Aggregated search need may reflect the user's attitude to such presentation. In some non-limiting embodiments, features describing aggregated search need may be presented as:

$${F}^{u} = \frac{C ( • , u , • v )}{S ( • , u , • v )} , \\ {F}_{30}^{u} = \frac{{C}_{30} ( • , u , • v )}{S ( • , u , • v )} , \\ {F}_{100}^{u} = \frac{{C}_{100} ( • , u , • v )}{S ( • , u , • v )}$$

$${F}_{l , 30}^{u} = \frac{{C}_{l , 30} ( • , u , • v )}{S ( • , u , • v )} , \\ {F}_{\%}^{u} = \frac{C ( • , u , • v )}{C ( • , u , • )}$$

where:

C(q, u, v) is the number of clicks made by user u on specific vertical result item v for query q;

S(q, u, v) is the number of times a vertical result item v was seen by user u following query q;

indicates the sum of all values for the indicated variable during the observed period of time (for example, C(, u, r) is

$${\sum }_{i} C ( {q}_{i} , u , r ) ,$$

where qᵢ are all the queries issued by user u during the observed period of time; as another example, v is the sum of all vertical search result items in all vertical domains);

F^{u} is a feature of the user's search history which is the ratio of number of clicks to the number of times seen for a vertical result item, u denoting that this feature relates to user's aggregated search need; and

C₃₀ is the number of clicks with a dwell time of more than 30 seconds; C₁₀₀ is the number of clicks with a dwell time of more than 30 seconds; C_{l,30} is the number of clicks which were the last clicks on the result search items and had a dwell time of more than 30 seconds.

In an embodiment, the vector of the five F^{u} features is denoted as φₐ(u).

It will be understood that F^{u}_{%} is the ratio of clicks on the sum of all vertical search results items (v) to clicks on the sum of all search results items (general search results items+vertical search results items). It thus represents the propensity of a user to click on a vertical search result item, as a percentage of all search result items (general+vertical).

In a non-limiting embodiment, “certain vertical preference” describes the user's demand for obtaining results of a certain type throughout all search queries. This feature may correlate highly with the user's interests and, for some users, may help to disambiguate some ambiguous queries for a concrete user. For example, a feature of this type may express the difference between the user's unigram language model (e.g., built on queries issued by the user during an observed period of time) and the language model for the result's vertical. This difference may be calculated as Kullback-Leibler divergence

$${\sum }_{w ∈ W} {P}_{{V}_{j}} ( w ) * log \frac{{P}_{{V}_{j}} ( w )}{{P}_{u} ( w )} ,$$

where Vⱼ=χ(rᵢ). If I(rᵢ) is zero, then this feature is set to zero.

As used herein, Vⱼ is the sum of all vertical search result items in a particular vertical domain, i.e., in vertical domain j. Thus the sum of all vertical search result items in a vertical domain is denoted as Vⱼ where j=1, . . . , N.

In another embodiment, “certain vertical preference” may be expressed by utilizing click information. For example, in a non-limiting embodiment, click information may be expressed by the following set of features:

$${F}^{uv} = \frac{C ( • , u , {V}_{j} )}{S ( • , u , {V}_{j} )} , \\ {F}_{30}^{uv} = \frac{{C}_{30} ( • , u , {V}_{j} )}{S ( • , u , {V}_{j} )} , \\ {F}_{100}^{uv} = \frac{{C}_{100} ( • , u , {V}_{j} )}{S ( • , u , {V}_{j} )}$$

$${F}_{l , 30}^{uv} = \frac{{C}_{l , 30} ( • , u , {V}_{j} )}{S ( • , u , {V}_{j} )} , \\ {F}_{\%}^{uv} = \frac{C ( • , u , {V}_{j} )}{C ( • , u , • )}$$

where:

C(q, u, Vⱼ) is the number of clicks made by user u on vertical search result items in vertical domain Vⱼ for query q; and j is I(rᵢ) (in other words, rᵢ is a particular result i within vertical domain j, where i and j are 1, . . . , N);

S(q, u, Vⱼ) is the number of times a vertical search result item in vertical domain Vⱼ was seen by user u following query q;

indicates the sum of all values for the indicated variable during the observed period of time (for example, C(, u, r) is

$${\sum }_{i} C ( {q}_{i} , u , r ) ,$$

where qᵢ are all the queries issued by user u during the observed period of time);

F^{uv} is a feature of the user's search history which is the ratio of number of clicks to the number of times seen for a vertical result item, uv indicating that this feature relates to user's certain vertical preference; and

C₃₀ is the number of clicks with a dwell time of more than 30 seconds; C₁₀₀ is the number of clicks with a dwell time of more than 30 seconds; C_{l,30} is the number of clicks which were the last clicks on the result search items and had a dwell time of more than 30 seconds.

In an embodiment, the vector of these F^{uv} features is denoted as φ_{c}(u, rᵢ). If j is 0, then the user prefers general search results, and these features would not be used.

In a non-limiting embodiment, “vertical navigationality” relates to the fact that, for some particular queries, the user's needs may not match his/her general, overall preferences. For example, for a particular query, the results from a news or weather vertical may be more relevant than the results from an image vertical for a user 908, 910 living in Amsterdam and issuing the query “Amsterdam” despite the user's usual preference for images. In one non-limiting embodiment, click-based features reflecting this intuition may be described as follows:

$${F}^{quv} = \frac{C ( q , u , {V}_{j} )}{S ( q , u , {V}_{j} )} , \\ {F}_{30}^{quv} = \frac{{C}_{30} ( q , u , {V}_{j} )}{S ( q , u , {V}_{j} )} , \\ {F}_{100}^{quv} = \frac{{C}_{100} ( q , u , {V}_{j} )}{S ( q , u , {V}_{j} )}$$

$${F}_{l , 30}^{quv} = \frac{{C}_{l , 30} ( q , u , {V}_{j} )}{S ( q , u , {V}_{j} )} , \\ {F}_{\%}^{quv} = \frac{C ( q , u , {V}_{j} )}{C ( q , u , • )}$$

where:

C(q, u, Vⱼ) is the number of clicks made by user u on vertical search result items in vertical domain Vⱼ for query q; and j is I(rᵢ), as defined above;

S(q, u, Vⱼ) is the number of times a vertical search result item in vertical domain Vⱼ was seen by user u following query q;

indicates the sum of all values for the indicated variable during the observed period of time (for example, C(, u, r) is

$${\sum }_{i} C ( {q}_{i} , u , r ) ,$$

where qᵢ are all the queries issued by user during the observed period of time);

F^{quv} is a feature of the user's search history which is the ratio of number of clicks to the number of times seen for a vertical result item, quv indicating that this feature relates to user's vertical preferences pertaining to vertical navigationality; and

C₃₀ is the number of clicks with a dwell time of more than 30 seconds; C₁₀₀ is the number of clicks with a dwell time of more than 30 seconds; C_{l,30} is the number of clicks which were the last clicks on the result search items and had a dwell time of more than 30 seconds.

In an embodiment, the vector of these F^{quv} features is denoted as φₙ(q, u, rᵢ).

In some embodiments, absolute values of the respective clicks and shows (times seen) may be added to each of the above feature vectors (for instance, S(, u, v) and C(, u, ) to φₐ(u), and so on); this reflects the user's activity level in respect to vertical search result items.

It is noted that the above feature vectors for “aggregated search need,” “certain vertical preference,” and “vertical navigationality” apply only to vertical results. Thus, if I(rᵢ) is zero (in other words, all search results items are general search results items, and there are no vertical search results items), then all elements of these three feature vectors are zero.

In some non-limiting implementations of the present technology, a feature of the user's search history is at least one of: the user's past preference for aggregated general content and vertical content, general content alone, or vertical content alone; the user's past preference for obtaining results from a specific vertical domain; and the user's intent for the search query. User's intent may include, as one example, user's intent for a particular type of vertical content, such as video content, image content, commerce content, music content, weather content, geographic content, text content, dictionary content, events content, news content, and/or advertising content.

In some non-limiting implementations of the present technology, a feature of the user's search history is at least one of: a click-through rate; a number of times a search result item was selected or clicked within a particular time period; a dwell-time after clicking; and whether a click on a result item was the last user action in a previous user session.

Returning now to step 602 of the method 600, the user-specific aggregation preference parameter has been generated based on at least one feature of the user's search history. In some implementations, the user-specific aggregation preference parameter has been generated prior to the user 908, 910 making the search query. In such implementations, the user-specific aggregation preference parameter may have been stored in the database 914 and is retrieved by the server 912 in the appreciating step. In other implementations, the user-specific aggregation preference parameter has been generated at the time the user 908, 910 makes the search query. In still other implementations, the user-specific aggregation preference parameter has been generated after the user 908, 910 made the search query. It should be understood that the time at which the user-specific aggregation preference parameter is generated is not particularly limited with respect to the time a particular search query is made. In some implementations the user-specific aggregation preference parameter has been generated and stored, e.g., in database 914, such that it can be retrieved from database 914 by the server 912 when needed for the appreciating step.

The method or algorithm used to generate the user-specific preference parameter is not particularly limited. In some non-limiting implementations of the present technology, the user-specific aggregation preference parameter is generated using a Gradient Boosted Decision Tree-based algorithm. In some implementations, the user-specific aggregation preference parameter is generated using a machine learning algorithm. In some implementations, the user-specific aggregation preference parameter is generated by accessing a log (not depicted) in the database 914, the log including at least one feature of the user's search history. The log may be stored, for example, in association with the user's credentials, in the database 914. Implementation of the log is not particularly limited.

It will be appreciated by those skilled in the art that features of a user's search history, such as a record of a user's previous activities, or a profile of a user 908, 910, may be created based on a previous search history of the user 908, 910 as determined, e.g., by cookies or other digital information stored on an electronic device 904, 906 that the user utilizes to perform searches, or on a server 912 (e.g., in a database 914). In some embodiments, a user 908, 910 may also be registered with a search engine which stores a history of the user's searches. In some embodiments, features of the user's search history stored in database 914, e.g., a log of user activity or search history, may be based on the previous search history of the user 908, 910 generated during a current search session. For example, if a user 908, 910 performed a first search and then performed a second search related to the first search based on the results from the first search, the results generated by the search engine for the second search may be based on features of the first search performed by the user 908, 910.

Step 604—Ranking the First General Search Result Item and the First Vertical Search Result Item Relative to Each Other Based at Least on the User-Specific Aggregation Preference Parameter, to Generate a Ranked Order of Search Results Items, the Method being Executable at a Server

Continuing now with the method 600, the first general search result item 102 and the first vertical search result item 104 are ranked relative to each other based at least on the user-specific aggregation preference parameter.

Ranking refers generally to identifying an order, position, or placements for search results items and/or components thereof, relative to each other. Search result items most relevant to a particular search query are generally provided with a higher ranking. A higher rank is used to refer to a rank that is stronger or otherwise indicates a higher priority or preference. Rankings can generally be based on any data such as, for example, click-through rates in query logs, history of user(s), query intent, results attributes (e.g., type or category of search results item), and a combination thereof. Rankings are used to determine where search results items, or components thereof, should be placed within a search results page. It will be understood by those skilled in the art that rankings may or may not be personalized or user-specific, i.e., they may or may not be based on the user's personal information, such as features of the user's search history.

Those skilled in the art will appreciate that there are various techniques available for ranking and/or personalizing search results. Just as an example and not as a limitation, some of the known techniques for ranking search results by relevancy are based on some or all of: (i) popularity of a given search query or a response thereto; (ii) number of results returned for a search query; (iii) whether the search query contains any determinative terms (such as “images”, “movies”, “weather” and the like); (iv) how often a particular search query is typically used with determinative terms by other users; and (v) how often other users performing a similar search have selected a particular resource or a particular vertical search results item when results were presented using a standard SERP. It should be understood that any such ranking and/or personalization techniques may be used in addition to, or in combination with, ranking based on the user-specific aggregation preference parameter.

For example, in some implementations, general search results may be ranked first using known ranking techniques, prior to ranking based on the user-specific aggregation preference parameter. Thus, in some implementations of the present technology, general search results items are ranked based on a general domain-ranking parameter, such as those known in the art, before ranking based on the user-specific aggregation preference parameter.

Similarly, in some implementations, vertical search results are ranked first using known ranking techniques for verticals, prior to ranking based on the user-specific aggregation preference parameter. Thus, in some implementations of the present technology, vertical search results items are ranked based on a vertical domain-ranking parameter, such as those known in the art, before ranking based on the user-specific aggregation preference parameter.

Those skilled in the art will appreciate that general search results obtained from a search engine are typically ranked using known ranking techniques, e.g., one or more general ranking algorithm, many of which are known in the art, before search results are retrieved or displayed. Similarly, vertical search results obtained from a search engine are typically ranked using known ranking techniques, e.g., one or more vertical ranking algorithm, many of which are known in the art, before search results are retrieved or displayed. Thus, it should be understood that in some embodiments of the technology, a first general search result item and a second general search result item have been ranked relative to each other using known ranking techniques, and a first vertical search result item and a second vertical search result item have been ranked relative to each other using known ranking techniques, prior to ranking based on the user-specific aggregation preference parameter. For example, in FIG. 1, the first general search result item 102 is ranked higher than the second general search result item 108, which is ranked higher than the third general search result item 110; these rankings are the result of ranking general search results using a general ranking algorithm, prior to aggregating general and vertical search results and ranking them relative to each other based on the user-specific aggregation preference parameter.

Such prior rankings may or may not be personalized, i.e., they may or may not be based on a user-specific ranking attribute. In some implementations, such prior rankings of general search results and/or vertical search results are based on known, general ranking techniques, and are not user-specific. In other implementations, such prior rankings of general search results and/or vertical search results are user-specific, i.e., are based on user-specific general or vertical ranking attributes. User-specific ranking attributes are based on the user's personal information, such as features of the user's search history, as described herein, and provide personalized rankings. In this way multiple levels of personalized ranking may be incorporated in methods and systems of the present technology, as general search results and/or vertical search results may first be ranked according to user-specific ranking attributes, before the general and vertical search results items are aggregated and ranked there-between, using the user-specific aggregation preference parameter.

In some implementations, where a user-specific general ranking attribute and a user-specific vertical ranking attribute are both used, they can be based on the same feature or set of features of the user's search history. In other implementations, where a user-specific general ranking attribute and a user-specific vertical ranking attribute are both used, they can be based on a different feature or set of features of the user's search history. In further implementations, where a user-specific general ranking attribute and a user-specific vertical ranking attribute are both used, they can be based on an overlapping set of features of the user's search history, i.e., they can be based on some but not all of the same features.

Similarly, in some implementations the user-specific aggregation preference parameter can be based on the same feature or set of features of the user's search history that is used to generate the user-specific general ranking attribute and/or the user-specific vertical ranking attribute. In other implementations, a different feature or set of features of the user's search history can be used to generate the user-specific aggregation preference parameter and the user-specific general ranking attribute and/or the user-specific vertical ranking attribute. In further implementations, the user-specific aggregation preference parameter, the user-specific general ranking attribute, and/or the user-specific vertical ranking attribute can be generated based on an overlapping set of features of the user's search history, i.e., they are based on some but not all of the same features.

In some non-limiting implementations, the method 600 further comprises a step of determining that the first general search result item and the first vertical search result item are relevant to the user's search query, prior to ranking them relative to each other.

The method 600 is executable at a server 912. As discussed, above, the implementation of the server 912 is not particularly limited. As an example, the server 912 may be implemented as a single server or as a plurality of servers.

Step 606—Causing an Electronic Device Associated with the User to Display the Ranked Order of Search Results Items within a Search Result Page (SERP) in Response to the Search Query

Continuing now with the method 600, in step 606, electronic device 904, 906 associated with the user 908, 910 is caused to display the ranked order of search results items within a search result page. Electronic device 904, 906 associated with the user 908, 910 is coupled communicatively with the server 912 such that a SERP is displayed on the electronic device 904, 9006 in response to the user 908, 910 having made a search query.

In step 606, the SERP displayed on the electronic device 904, 906 associated with the user 908, 910 in response to the search query displays search results items in the ranked order generated by the ranking in step 604. In the example shown in FIG. 1, there is shown a screenshot of a SERP displaying search results aggregated according to the present technology. The SERP in FIG. 1 displays a first vertical search result item 104 having image components 116, 118, 120, followed by a first general search result item 102, a second general search result item 108, and a third general search result item 110, followed finally by a second vertical search result item 106 having image components 122, 124, 126. In this SERP, which is provided as an example only, the first vertical search result item 104 is ranked the highest and is thus displayed first on the page. The general search result items 102, 108, 110 are ranked lower than the first vertical search result item 104 and higher than the second vertical search result item 106, and are shown accordingly in the middle, between the two vertical search result items 104 and 106.

The first general search result item 102 is ranked higher than the second general search result item 108, which is ranked higher than the third general search result item 110; the general search result items are displayed accordingly in that order, from top to bottom on the SERP.

In the example shown in FIG. 1, the three general search result items 102, 108, 110 are displayed together in a block, between the two vertical search result items 104, 106. However, other implementations are possible, and will depend on the user-specific aggregation preference parameter. For example, a first vertical search result item 104 and a second vertical search result item 106 may be ranked and displayed separately within the SERP as shown in FIG. 1, or may be ranked together and displayed as a block within the SERP (not depicted). As another example, a first general search result item 102 may be ranked higher than the first vertical search result item 104, and displayed accordingly at the top of the SERP (not shown). It will be appreciated by those skilled in the art that many such permutations are possible.

It should also be understood that the arrangement of search results is not particularly limited. For example, search results may be arranged vertically, horizontally, in a grid pattern, or in some combination thereof. Presentation of the search results within the SERP may vary depending on the type of electronic device 904, 906 associated with the user 908, 910. For example, a display for a desktop computer may be larger than a display for a notebook, netbook, or tablet, which may themselves be larger than a display for smaller electronic devices, such as mobile phones. The size of the display may affect the number of search results items displayed within a SERP to the user 908, 910, as well as the number of sublinks, snippets (e.g., snippet 132), or amount of summary information (e.g., summary information 128, 130) displayed. In some embodiments, the position of the search results items 102, 104, 106, 108, 110 within the SERP may be referred to as the rank of the search results items on the SERP. However, in some embodiments, rank may be reflected in display attributes other than, or in addition to, position, such as prominence, size, color, etc., within the SERP.

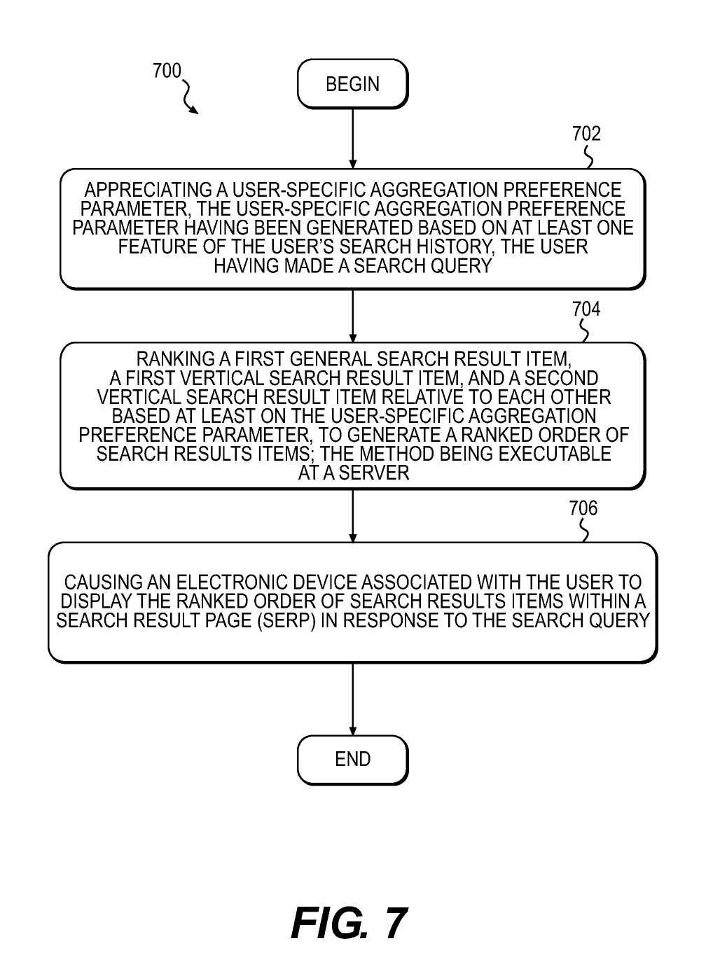

Reference will now be made to FIG. 7, which depicts a block diagram of a method 700, the method 700 being implemented in accordance with non-limiting embodiments of the present technology. The method 700 can be conveniently executed at a server 912.

Step 702—Appreciating a User-Specific Aggregation Preference Parameter

Like the method 600, the method 700 begins at step 702, where a server 912 appreciates a user-specific aggregation preference parameter, the user-specific aggregation preference parameter having been generated based on at least one feature of the user's search history, the user 908, 910 having made a search query. The method 700 further comprises a second vertical search result item.

Steps 704 and 706—Ranking the First General Search Result Item, the First Vertical Search Result Item, and the Second Vertical Search Result Item Relative to Each Other Based at Least on the User-Specific Aggregation Preference Parameter, to Generate a Ranked Order of Search Results Items, and Causing an Electronic Device Associated with the User to Display the Ranked Order of Search Results Items within a Search Result Page (SERP) in Response to the Search Query

The method 700 continues with steps 704 and 706, where a first general search result item 102, a first vertical search result item 104, and a second vertical search result item 106 are ranked relative to each other, based at least on the user-specific aggregation preference parameter, to generate a ranked order of search results items, and the ranked order of search result items is displayed within a SERP. In the example shown in FIG. 1, the first vertical search result item 104 and the second vertical search result item 106 are identified by searching two different vertical domains. The first vertical search result item 104 is identified by searching a first vertical domain 112 (video), and the second vertical search result item 106 is identified by searching a second vertical domain 114 (images). In some alternative implementations, the first vertical search result item and the second vertical search result item may be identified by searching the same vertical domain (not shown). It should be understood that where more than one vertical search result item is displayed on a SERP, they may come from searching the same vertical domain, or from searching different vertical domains. Further, two vertical search result items identified from searching one vertical domain may be displayed separately within a SERP or may be displayed together within a SERP, depending on the user-specific aggregation preference parameter.

In some non-limiting implementations, the method 700 further comprises a step of determining that the first general search result item, the first vertical search result item, and the second vertical search result item are relevant to the user's search query, prior to ranking them relative to each other.

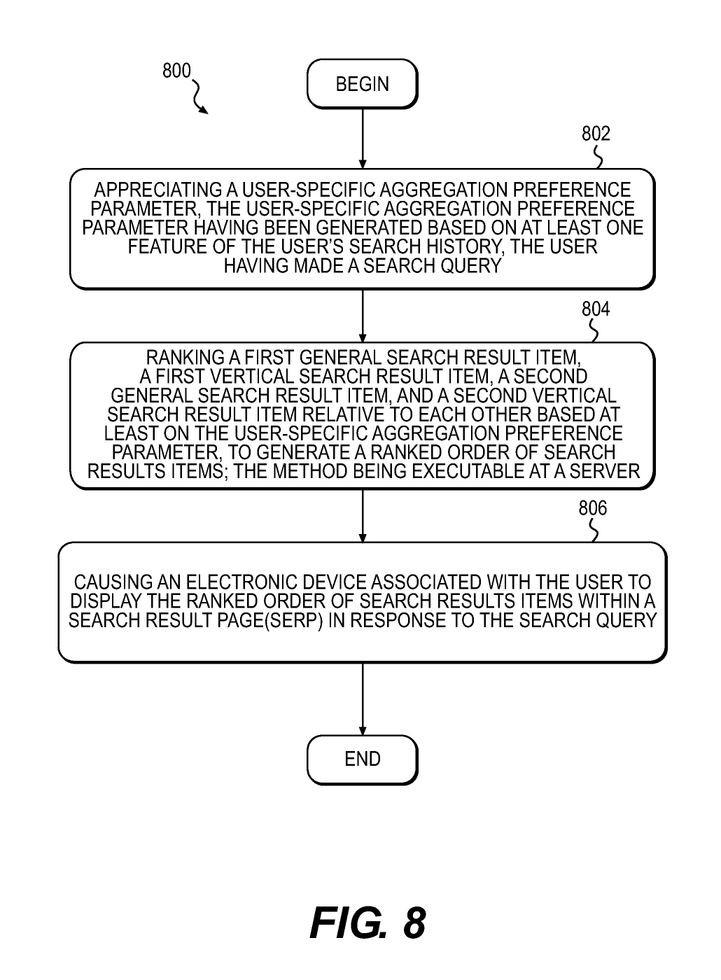

Reference will now be made to FIG. 8, which depicts a block diagram of a method 800, the method 800 being implemented in accordance with non-limiting embodiments of the present technology. The method 800 can be conveniently executed at a server 912.

Step 802—Appreciating a User-Specific Aggregation Preference Parameter

Like the method 700, the method 800 begins at step 802, where a server 912 appreciates a user-specific aggregation preference parameter, the user-specific aggregation preference parameter having been generated based on at least one feature of the user's search history, the user having made a search query. The method 800 further comprises a second general search result item.

Steps 804 and 806—Ranking the First General Search Result Item, the First Vertical Search Result Item, the Second Vertical Search Result Item, and the Second General Search Search Result Item Relative to Each Other Based at Least on the User-Specific Aggregation Preference Parameter, to Generate a Ranked Order of Search Results Items, and Causing an Electronic Device Associated with the User to Display the Ranked Order of Search Results Items within a Search Result Page (SERP) in Response to the Search Query

The method 800 continues with steps 804 and 806, where a first general search result item 102, a first vertical search result item 104, a second vertical search result item 106, and a second general search result item 108 are ranked relative to each other, based at least on the user-specific aggregation preference parameter, to generate a ranked order of search results items, and the ranked order of search result items is displayed within a SERP. In the example shown in FIG. 1, the first general search result item 102 and the second general search result item 108 are displayed together, with the first general search result item 102 being ranked just above the second general search result item 108 and accordingly displayed just higher than the second general search result item 108 within the SERP. In some alternative implementations, the first general search result item and the second general search result item may be displayed separately on the SERP, as they may be ranked separately. For example, a vertical search result item may be ranked in between the first general search result item and the second general search result item (not shown). In another alternative, the second general search result item may be ranked higher than the first general search result item (not shown). It should be understood that many such permutations are possible, and will depend on the user-specific aggregation preference parameter and the corresponding ranked order of search results items that is generated.

In some non-limiting implementations, the method 800 further comprises a step of determining that the first general search result item, the first vertical search result item, the second vertical search result item, and the second general search result item are relevant to the user's search query, prior to ranking them relative to each other.

The present disclosure is not to be limited in terms of the particular embodiments described herein, which are intended as illustrations of various aspects. Many modifications and variations may be made, as will be apparent to this skilled in the art. Functionally equivalent methods and systems within the scope of the disclosure, in addition to those enumerated within, will be apparent to those skilled in the art. In an illustrative embodiment, any of the operations, processes, etc. described herein may be implemented as computer-readable instructions stored on a non-transitory computer-readable storage medium. The computer-readable instructions may be executed by a processor of a mobile unit, a network element, and/or any other computing device, causing performance of the methods described herein.

In additional non-limiting implementations of the present technology, there is provided a server 912 configured for presenting a search result page (SERP) to a user 908, 910 in response to a search query, the server 912 having a transient computer usable information storage medium that stores computer executable instructions, which instructions when executed are configured to render the server operable to execute the steps of the methods described herein.

### Examples

The present technology is more readily understood by referring to the following examples, which are provided to illustrate the technology and are not to be construed as limiting the scope thereof in any manner.

Unless defined otherwise or the context clearly dictates otherwise, technical and scientific terms used herein have the same meaning as commonly understood by one of ordinary skill in the art to which this invention belongs. It should be understood that any methods and materials similar or equivalent to those described herein can be used in the practice or testing of the invention.

In the Examples discussed below, personalization of aggregated search results was demonstrated in response to the search query “metallica”. First, personalization of verticals ranking was performed following methodology as described. The original ranking algorithm presented 10 web results and a number of vertical results injected in-between. Note that a vertical result could sometimes be presented as a block of top-ranked documents of a certain type as in FIG. 1, where vertical search result item 104 includes a block of three image components 116, 118, and 120. To avoid this ambiguity, hereinafter the term “vertical result” is used to mean a block of at least one vertical component.

The original result pages satisfied the following constraints: First, there could only be no more than one vertical result inserted for each vertical. Second, the vertical results could only be embedded into four slots: above the first web result; between the third and the fourth results; between the sixth and the seventh results; and after the tenth web result. FIG. 1 shows the top portion of a SERP satisfying these constraints.

In certain experiments the search results were aggregated in any order, violating the above-described constraints, if necessary. As we considered only queries for which at least one vertical result was presented, from 11 up to 14 heterogeneous results were aggregated. For experimental purposes, we also worked with the following set of verticals: Images, Video, Music, News, Dictionaries, Events, and Weather. It should be understood that the approach used here is for illustrative purposes only, and our approach could be easily applied to any other set of vertical domains.

To proceed with the aggregation functions, we composed a multidimensional feature vector φ(q, u, rᵢ) for each result rᵢ corresponding to query q issued by user u. It is noted that result rᵢ could be either a web result or a vertical result for any vertical domain. If the result was relevant for the user, this vector was labeled with 1, otherwise it was labeled with 0. Next, a point-wise approach was used to train the ranking model and all results were aggregated according to the model score.

In the following sections we describe the feature vectors construction for different experimental settings, but, first, we introduce the notation used herein.

The following notation was used herein: Each observed vertical was denoted as Vj, j=1, . . . , N. For each result rᵢ there was an indicator function I(rᵢ) that outputted j if rᵢ was the result of vertical Vⱼ (e.g., a vertical result) and 0 if it was the result of searching the general domain (e.g., a general result, such as a general web result). χ(rᵢ) was the formal function that outputted rᵢ, if I(rᵢ)=0, and V_{I(ri)} otherwise. C(q, u, r) denoted the number of clicks made by user u on specific result r (specific result r being a search result item from a vertical domain or from a general domain) for query q. C₃₀(q, u, r) and C₁₀₀(q, u, r) were the counts of clicks having dwell-time more than 30 and 100 seconds, respectively. By C_{l,30}(q, u, r) was meant the number of clicks which were the last clicks on the results for the respective query q and had dwell-time of more than 30 seconds. By means of this notation, we could denote C(, u, r) as

$${\sum }_{i} C ( {q}_{i} , u , r ) ,$$

where qᵢ were all the queries issued by user u during the observed period of time. Aggregated values such as C(q, , r) or C(q, , ) could be defined in the same way. Further, C(q, u, Vⱼ) was denoted as the sum of the clicks of user u on all the results of the vertical Vⱼ presented for query q during the observed period of time. As these results could actually be different at different moments, this value was treated as “clicks on vertical”. C(q, u, v) was denoted as the sum of C(q; u; Vⱼ) for all verticals.

The number of times any result r was seen by user u following query q was referred to as S(q, u, r). We considered a result as “seen” in one of the following cases: 1) if the result was placed in the first position; 2) if it was clicked; or 3) if a document positioned lower was clicked. In accordance with the definitions above, it was easy to proceed with definitions of values like S(q, u, v), S(q, u, ), etc. Similar notation has been described¹¹.

We now describe baseline features. First, the construction of user-independent baseline feature vector φ_{B}(q, r) is described. The first element of φ_{B}(q, r) is I(r), so that a learning method was always informed of the type of the result (i.e., whether it was a search result item from a general domain (e.g., the world wide web) or a search result item from a vertical domain (e.g., images or news results). Features unavailable for a certain result type were set to zero; hence, the first element of φ_{B}(q, r) indicated such situations.

To build a competitive baseline, we implemented the following features, representative of ones known in the art.

Query Data.

As described, a boolean variable indicating whether the query was considered to be navigational was included into the baseline feature set. For each vertical Vⱼ, a unigram vertical language model Lⱼ was also built. Each model was built based on the queries for which the result from Vⱼ was clicked with dwell time more than 30 seconds, which is an accurate and widely-used indicator of result relevance. So, if the vertical result was r and I(r)=j, we added query likelihood to the feature vector φ_{B}(q, r). If r was a search result item from a general domain (e.g., a general web result), we appended zero to φ_{B}(q, r) (and the machine learning algorithm was informed about the result type due to the first coordinate of φ_{B}(q, r)). Query texts were preferred over document texts to build our models because some of the vertical domains operated with non-textual content and we wanted to treat the vertical domains consistently. Another reason is that models constructed in such a manner have very similar semantics to keyword features and thus provided our aggregation functions with this type of signal too. Query length was also added as a feature.

Vertical Data and General Data.

The first feature of this type was the result position in the original ranking. The result relevance score estimated by the original ranking algorithm only for web documents was also utilized as a feature. Note that our baseline set of features included the features needed to produce the non-personalized version of the vertical relevance score, so, for the sake of proper comparison of personalized and non-personalized approaches, we measured the relevance of verticals explicitly and did not obtain it elsewhere.

Search-Log Data.

The next features we used were the following five click-based ones:

$${F}^{c} = \frac{C ( q , • , χ ( r ) )}{S ( q , • , χ ( r ) )} , \\ {F}_{30}^{c} = \frac{{C}_{30} ( q , • , χ ( r ) )}{S ( q , • , χ ( r ) )} , \\ {F}_{100}^{c} = \frac{{C}_{100} ( q , • , χ ( r ) )}{S ( q , • , χ ( r ) )}$$

$${F}_{l , 30}^{c} = \frac{{C}_{l , 30} ( q , • , χ ( r ) )}{S ( q , • , χ ( r ) )} , \\ {F}_{\%}^{c} = \frac{C ( q , • , χ ( r ) )}{C ( q , • , • )} .$$

It is noted that similar features were already used by the search engine original ranking algorithm, but we explicitly added them to φ_{B}(q, r) to emphasize the effect of the personalized approach described herein. If χ(r) is Vⱼ, these features give us information about the clicks on vertical search result items.

Personalization Features.

Three classes of vertical domain-related (also referred to herein as “vertical-related”) personalization features were proposed: 1) Aggregated search need; 2) Certain vertical preference; and 3) Vertical navigationality. These personalization features are now described further below.

1. Aggregated Search Need.

This set of features describes whether the user was generally interested in aggregated search results and preferred them to general web results. Vertical results often have a presentation which differs from general web results, and can affect the user experience. This set of features was intended to reflect the user's attitude to such changes. In this example, we proceeded by utilizing historic click information. In particular, the set of features was as follows:

$${F}^{u} = \frac{C ( • , u , • v )}{S ( • , u , • v )} , \\ {F}_{30}^{u} = \frac{{C}_{30} ( • , u , • v )}{S ( • , u , • v )} , \\ {F}_{100}^{u} = \frac{{C}_{100} ( • , u , • v )}{S ( • , u , • v )}$$

$${F}_{l , 30}^{u} = \frac{{C}_{l , 30} ( • , u , • v )}{S ( • , u , • v )} , \\ {F}_{\%}^{u} = \frac{C ( • , u , • v )}{C ( • , u , • )} .$$

The vector of these five features was denoted as φₐ(u).

2. Certain Vertical Preference.

This set of properties describes the user's demand for obtaining results of a certain type throughout all queries. This is believed to correlate highly with the user's interests. Further, adding features of this type to the user's personalization profile could help to disambiguate some ambiguous queries for a concrete user.

The first feature of this class expressed the difference between a user's unigram language model (built on the queries issued by the user during the observed period of time) and the language model for the result's vertical search result items (described in the section titled “Baseline Features” above). The difference was calculated as Kullback-Leibler divergence

$${\sum }_{w ∈ W} {P}_{{V}_{j}} ( w ) * log \frac{{P}_{{V}_{j}} ( w )}{{P}_{u} ( w )} ,$$

where Vⱼ=χ(rᵢ). If I(rᵢ)=0, this feature was set to zero.

Another way to express the motivation above was to utilize click information. The next set of features were proposed for this purpose:

$${F}^{uv} = \frac{C ( • , u , {• V}_{j} )}{S ( • , u , {• V}_{j} )} , \\ {F}_{30}^{uv} = \frac{{C}_{30} ( • , u , {• V}_{j} )}{S ( • , u , {• V}_{j} )} , \\ {F}_{100}^{uv} = \frac{{C}_{100} ( • , u , {• V}_{j} )}{S ( • , u , {• V}_{j} )}$$

$${F}_{l , 30}^{uv} = \frac{{C}_{l , 30} ( • , u , {• V}_{j} )}{S ( • , u , {• V}_{j} )} , \\ {F}_{\%}^{uv} = \frac{C ( • , u , {• V}_{j} )}{C ( • , u , • )} .$$

Here j=I(rᵢ). The feature vector of these six features was denoted as φ_{c}(u, rᵢ).

3. Vertical Navigationality.

On the other hand, a user's needs may not match his/her overall preferences for some particular queries. For example, the results from a News or Weather vertical domain may be more relevant than the results from an Image vertical domain for a user living in Amsterdam and issuing query “Amsterdam” despite his/her usual preference for Images. Click-based features reflecting this intuition were evaluated as follows:

$${F}^{quv} = \frac{C ( q , u , {V}_{j} )}{S ( q , u , {V}_{j} )} , \\ {F}_{30}^{quv} = \frac{{C}_{30} ( q , u , {V}_{j} )}{S ( q , u , {V}_{j} )} , \\ {F}_{100}^{quv} = \frac{{C}_{100} ( q , u , {V}_{j} )}{S ( q , u , {V}_{j} )}$$

$${F}_{l , 30}^{quv} = \frac{{C}_{l , 30} ( q , u , {V}_{j} )}{S ( q , u , {V}_{j} )} , \\ {F}_{\%}^{quv} = \frac{C ( q , u , {V}_{j} )}{C ( q , u , • )} .$$

Again, here j=I(rᵢ) and the feature vector of these five features was denoted as φₙ(q, u, rᵢ).

We added the absolute values of the respective clicks and shows to each of these feature vectors (for instance, S(, u, v) and C(, u, ) to φₐ(u) and so on). In this way, our models were informed of the user's activity level in respect to the vertical search result items which could also have useful signal for the learning algorithm. Another reason for adding these features was that the remaining features became more reliable with larger values of activity features. Thus, providing the learning algorithm with such information was also helpful for the entire learning process.

It is noted that these feature vectors made sense only for vertical search result items. Therefore, if I(rᵢ)=0, then all the elements of these three feature vectors were equal to zero.

Aggregation Functions.

We trained a number of aggregation functions, each differing in the sets of features they used. To train the models we used a Gradient Boosted Decision Trees (GBDT)-based algorithm configured for minimizing mean squared error (MSE). GBDT-based algorithms are known in the art and have been used previously^{3,13}. It should be understood that many different algorithms could be used, and the choice of algorithm was not central to these experiments. In implementations illustrated here, we selected a Decision Trees-based algorithm as we wanted our ranking functions to be vertical-sensitive and to use some features only if they were available for the certain result type (for example, some personalization features were not available for general search results). It is expected that any other reasonable Decision Trees-based algorithm would provide similar results.

We used the same learning algorithm parameters (shrinkage rate, size of trees) as those used for training production ranking function of one of the major, commercially-available search engines.

Baseline ranking function R_{B} was trained according to the scheme described above, using features vector φ_{B}(q,r). This feature vector included the position of the result in the original ranking which represented a production ranking of one of the major search engines. On the other hand, it included the representative set of features discussed above (query data, vertical data, click-through data, and web data). Thus, this set of features provided us with a very competitive baseline.

To evaluate the potential of personalization for improving presentation of aggregated search results and to estimate the strengths of different personalization feature classes, we also trained four more ranking functions. R_{acn} function was trained on the concatenation of the feature vectors φ_{B}, φₐ, φ_{c}, φₙ, R_{ac} was trained on the concatenation of the feature vectors φ_{B}, φₐ, φ_{c}, φₐₙ on vectors φ_{B}, φₐ, φₙ, and R_{cn} on vectors φ_{B}, φ_{c}, φₙ.

Dataset and Experiment Protocol.

To perform our experiments we collected user sessions from search logs of a major commercial search engine. For each query these logs contained the query itself, the top results returned by the search engine in response to the query, and click information about the results. All of the users of this search engine were assigned a special anonymous User Identifier (UID) cookie, which was also stored in the logs and allowed us to distinguish actions performed by different users. Our dataset consisted of eight weeks of user sessions logged during May and June 2012. We considered only search results which included at least one vertical search result item. It should be understood that many different search engines could be used, and the choice of search engine was not central to these experiments. It is expected that any other reasonable search engine would provide similar results.

Since our goal was to evaluate personalized features, it was not possible to use assessors' judgements. Instead, we retrieved information about results relevance from the search logs. We considered a result to be relevant for a particular query if it was clicked with dwell time more than 30 seconds or if the click on the result was the last user action in the session. Otherwise, the presented results were considered irrelevant.

To build the training and test sets we used the sessions from the seventh and eighth weeks of our observations, respectively. Datasets were constructed in such a manner in order to ensure that models were not tested on sessions from the same period used for learning, as this could have biased the results. For both datasets we considered only queries for which at least one result had a positive judgement and for which a vertical search result item was seen in accordance with the definition of “seen” given above. To build search logs features (both personalized and non-personalized) for the training set we used the sessions from weeks 1-6, and for the test set we used the sessions from weeks 2-7, so the same amount of information was used for training and testing.

Our final user pool consisted of users who saw a result from any vertical at least 5 times during both periods of feature collection (weeks 1-6 and 2-7). It should be noted that users were not filtered by their activity during the test period, which could also have biased the obtained results. Such filtering provided us with about 30 million distinct users. Both the training and the test sets consisted of approximately 100 million queries, and about 70% of these queries were issued by the users from our user pool. We randomly selected 10% of the collected profiles in this user pool for use in our experiments. Due to the random sampling, this subset reflected the characteristics of the user profiles pool as a whole. Thus, our final user pool consisted of about 3 million users, and the training and test sets included search results for about 7 million queries.

All the ranking functions were trained and then evaluated in the same manner using a user-specific version of five-fold cross-validation, which was set up as follows. The final user profiles pool was split into 5 folds. During each cross-validation iteration, four user profiles folds were used for training and the remaining fold was retained for testing. To train the model we took the sessions from the training set (week 7), which were committed by the users from the four learning folds. After that the model was tested on the sessions from the test dataset (week 8) made by the users from the validation fold. This procedure was then repeated five times, so that each fold was used exactly once as the validation data. This form of cross-validation ensured that the obtained results were not biased towards the users used for learning.

TABLE 1
Aggregation results for test dataset.

| | R_{acn}, % | | R_{cn}, % | Rₐₙ, % | R_{ac}, % |
|---|---|---|---|---|---|
| All | 3.00 ▴ | 13.42 | 2.92 ▴ ▾ | 2.31 ▴ ▾ | 2.94 ▴ ▾ |
| CE <0.5 | 1.90 ▴ | 6.69 | 1.86 ▴ | 1.35 ▴ ▾ | 1.86 ▴ |
| 0.5 ≦ CE < 1 | 3.01 ▴ | 14.43 | 2.93 ▴ ▾ | 2.43 ▴ ▾ | 2.93 ▴ ▾ |
| 1 ≦ CE | 3.30 ▴ | 14.49 | 3.18 ▴∇ | 2.25 ▴ ▾ | 3.19 ▴ ▾ |

### Results

Aggregation quality was measured by the mean of average precision of the aggregated documents for the queries in each test fold (Mean Average Precision, or MAP) and then averaged over folds. Relative improvements of the personalized algorithms over the baseline ranking are shown in Table 1 in accordance with previous studies.

We also measured the performance of our models over a number of query stream subsets, as it has been reported that changes in query click entropy correlate highly with the profit which could be obtained by personalizing the documents ranking for this query. The term “entropy” is commonly used in the art and refers to the average uncertainty in a random variable. We adapted common click entropy to the needs of the aggregated search, i.e. we did not use the click probability for each specific result. Instead we used the aggregated probabilities of a click on all the general search results and the probability of a click for each vertical search result. More formally:

$${P}_{{V}_{j}} = \frac{C ( q , • , {V}_{j} )}{C ( q , • , • )} , \\ {P}_{web} = 1 - {\sum }_{j} {P}_{{V}_{j}} , \\ {CE}_{A} ( q ) = {\sum }_{j} ( - {P}_{V} , * {log}_{2} ( {P}_{{V}_{j}} ) ) - {P}_{web} * {log}_{2} ( {P}_{web} ) .$$

Overall Performance.

The overall results of all our models are presented in Table 1. The column header indicates the applied model. Symbol ▴ denotes the 99% (p-value<0.01) statistical significance level of improvements over the baseline according to the Wilcoxon paired signed-rank test for each of the five test folds. Symbol ▾ means that the corresponding model performed significantly worse than R_{acn} model on each fold with p-value<0.01. ∇ means the same with p-value<0.05.

The right part of R_{acn} column shows the improvements for the queries, where MAP of the rankings produced by the baseline R_{b} model and personalized R_{acn} model differed. Such queries comprised approximately 29% of the query stream of each testing fold. MAP grew for 18% of the stream so we improved the ranking for 62% of the queries affected by our aggregation.

From this table we can see that all four personalized models significantly improved ranking quality.

The following sections provide more detailed analysis of the performance of R_{acn} model depending on the query, the user or the presented verticals.

Query-Level Analysis.

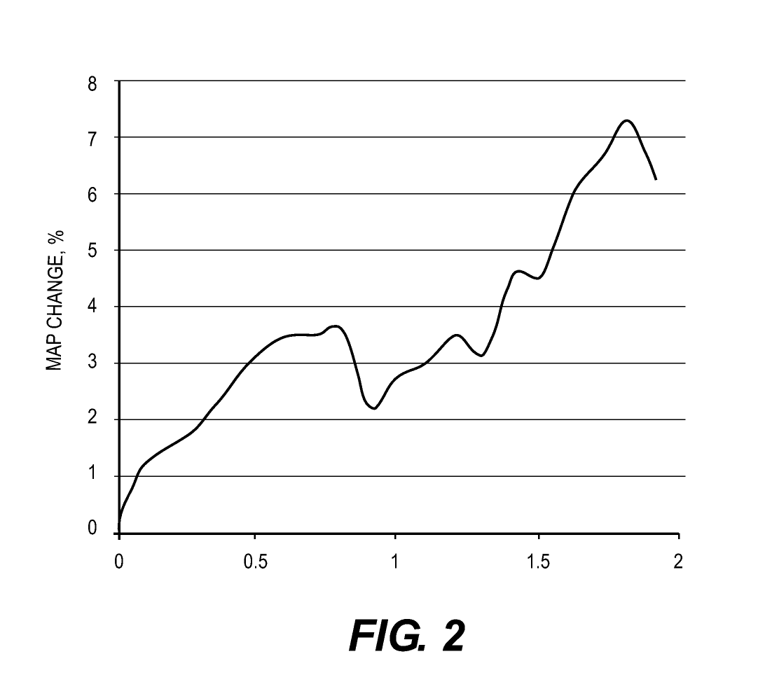

First, we considered the dependence of the impact of personalized approach on the changes in click entropy in more detail (however, overall performance of the personalized models for the queries with known click entropy always improved on average). FIG. 2 shows MAP improvements as a function of adapted click entropy (see the beginning of the section headed “Results” above for the definition of adapted click entropy). This graph shows that in general growth of entropy led to increased effect of personalization for vertical search results ranking. We can see a positive effect even for the queries with low entropy and despite the decline in MAP improvements to the left of 1, the average growth of MAP in the range between 0.5 and 1 still surpassed this value counted for the [0, 0.5]-interval, as shown in Table 1.

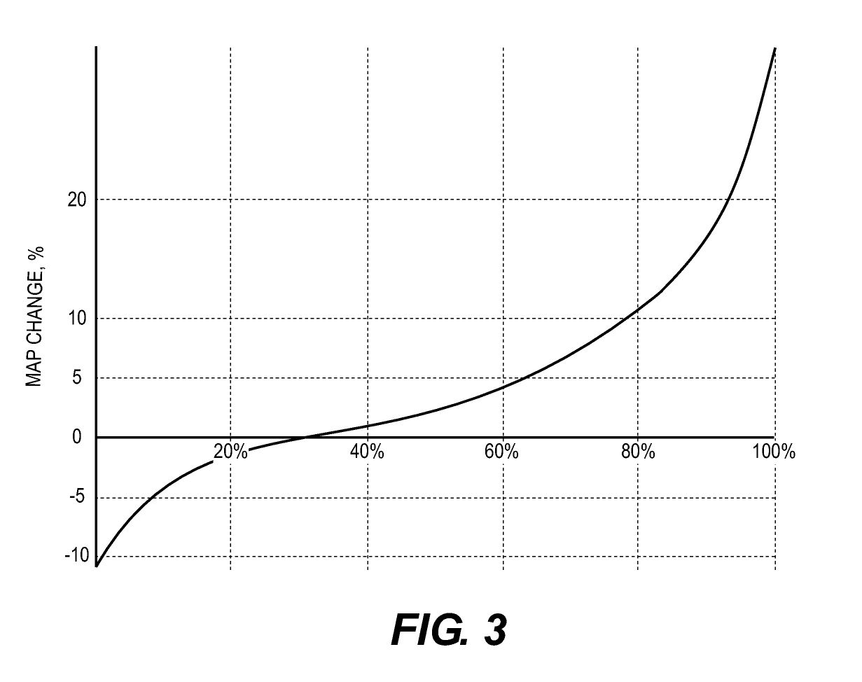

As mentioned above, our aggregation affected 29% of the query stream of each testing fold, which consisted of approximately 1.2 million queries. On the other hand, each test fold consisted of approximately 680,000 unique queries. The share of unique queries, affected by our aggregation, was 32%, 61% of which was aggregated positively. It should be noted that the same query issued by different users might have been aggregated in different ways or not aggregated at all. We considered a unique query affected if the rankings of R_{b} and R_{acb} models differed for any of its occurrences in the dataset. FIG. 3 shows the average aggregation performance of the personalized model for the share of the unique queries (issued at least 5 times) between the 5th and 95th percentiles of the sample of such queries sorted by MAP growth. The occurrences of the query were counted during the eighth week of observations.

User-Level Analysis.

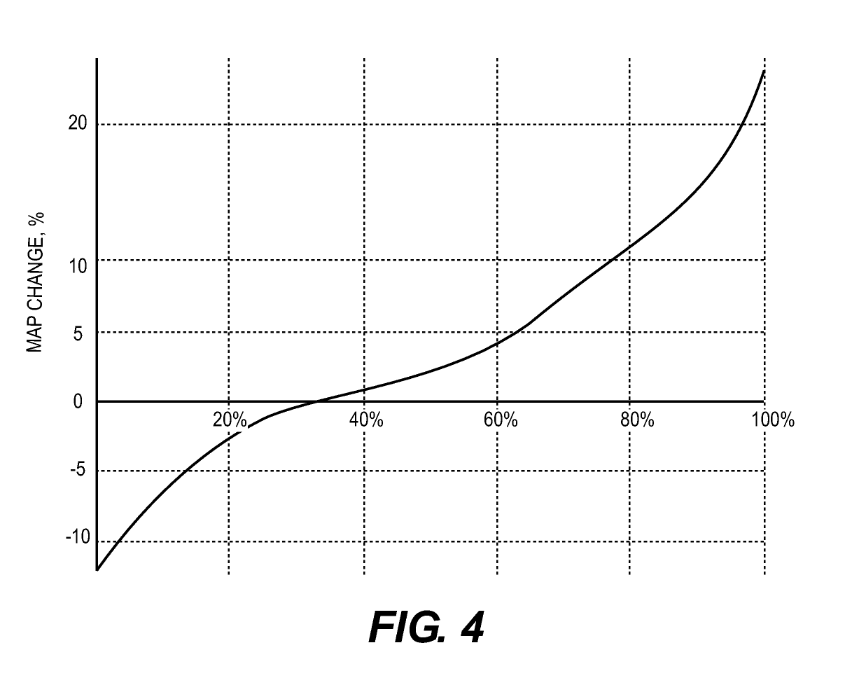

Another valuable aspect of the analysis of personalized models was their influence on distinct users. As the 3 million user pool was split into 5 non-overlapping folds, each user-fold consisted of approximately 600,000 users. However, the corresponding part of the test dataset contained the queries issued by only about 450,000 users, since not all the observed users were active during the eighth week of observations. The sessions of 54% of these users were affected by our aggregation and for 64% of them the personalized aggregation had a positive effect. FIG. 4 shows the distribution of average MAP growth for the share of the users between the 5th and 95th percentiles of the sample of the users who issued at least 5 queries during the eighth week.

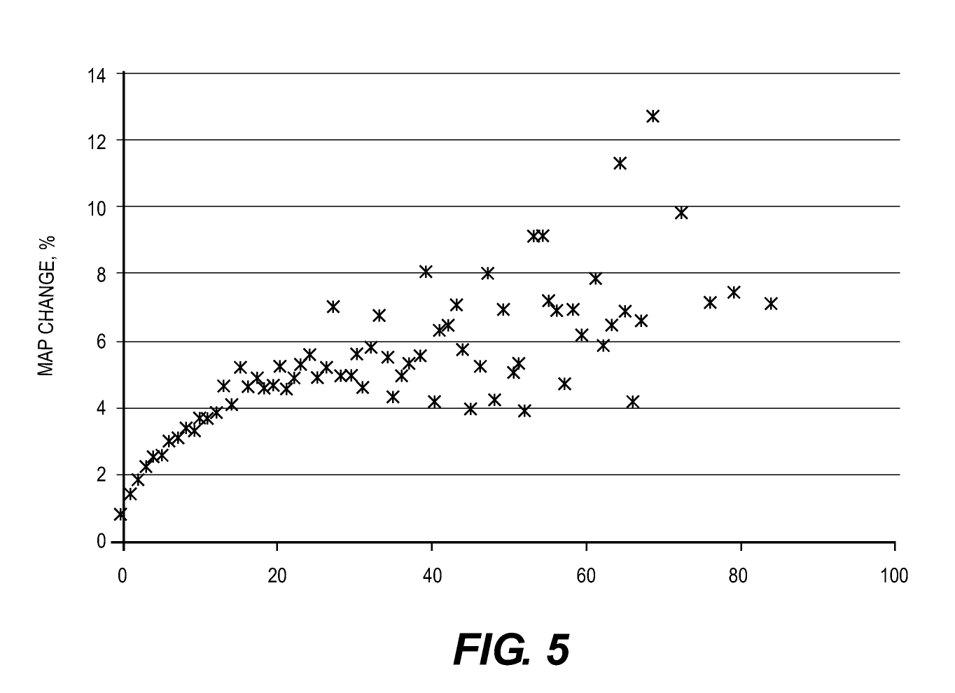

To find out the classes of the users which differed by the effect of personalization, we split the users into buckets depending on the number of times each user saw vertical domain search results during the feature collection period. Thus, if a user saw vertical domain search results k times, she was assigned to the bucket numbered [(k−5)/5]. We selected top of such buckets by the number of assigned users. Average MAP changes inside a bucket as a function of the bucket number is presented in FIG. 5. Although the average MAP inside each bucket grows, we can see that the value of this growth highly depended on the number of a bucket and therefore on the number of times the user had seen any vertical. It is important to highlight here, that this number was calculated during the feature collection period, so it could be used in the learning process, for instance, by training different models for users with different levels of aggregated search-related activity.

SERP Analysis.

As the next direction of our analysis we studied how the effect of personalization depends on the verticals presented on the SERP. First, we measured how the personalized aggregation changed the order of vertical results if the SERP contained at least two of them. For this purpose we calculated MAP considering only verticals results and obtained 1.24% growth (p-value<0.01 on each fold). We also studied the dependence of MAP growth on the number of presented verticals on the SERP and got the following results: for 1 vertical result presented (75% queries) MAP grew by 2.72%, for 2 presented verticals (22% queries) MAP grew by 3.80%, for 3 presented vertical results the growth was 4.31% (2.5% queries) and for 4 results growth was 3.43% (approximately 0.5% queries). All the changes were significant with p-value<0.01 for each 5 folds. We also studied which verticals benefited more or less from personalization approach and found that for Video and Weather verticals profit was the most (5.35% and 8.2%), but for Dictionaries and Events verticals we failed to achieve significant improvements.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of presenting a search result page (SERP) to a user in response to a search query, the SERP including a first general search result item and a first vertical search result item, the method executable at a server, the method comprising:
appreciating a user-specific aggregation preference parameter, the user-specific aggregation preference parameter having been generated based on at least one feature of the user's search history;
aggregating the first general search result item and the first vertical search result item into an aggregated set of search results;
ranking the first general search result item and the first vertical search result item relative to each other within the aggregated set of search results based at least on the user-specific aggregation preference parameter, to generate a ranked order of search results items; and
causing an electronic device associated with the user to display the ranked order of search results items within the SERP.

2. The method of claim 1, wherein:
the SERP includes a second vertical search result item; and
the first general search result item, the first vertical search result item, and the second vertical search result item are ranked relative to each other based at least on the user-specific aggregation preference parameter, to generate the ranked order of search results items.

3. The method of claim 2, wherein the first vertical search result item and the second vertical search result item are ranked together relative to the general search result item and displayed as a block within the SERP.

4. The method of claim 2, wherein the first vertical search result item and the second vertical search result item are ranked and displayed separately within the SERP.

5. The method of claim 1, wherein:
the SERP includes a second general search result item; and
the first general search result item, the first vertical search result item, the second vertical search result item, and the second general search result item are ranked relative to each other based at least on the user-specific aggregation preference parameter, to generate the ranked order of search results items.

6. The method of claim 1, wherein the first general search result item is ranked based on a general domain-ranking parameter, before said ranking based at least on the user-specific aggregation preference parameter.

7. The method of any one of claim 1, wherein the first vertical search result item is ranked based on a vertical domain-ranking parameter, before said ranking based at least on the user-specific aggregation preference parameter.

8. The method of claim 5, wherein the first general search result item and the second general search result item are ranked based on a general domain-ranking parameter, before said ranking based at least on the user-specific aggregation preference parameter.

9. The method of claim 5, wherein the first vertical search result item and the second vertical search result item are ranked based on a vertical domain-ranking parameter, before said ranking based at least on the user-specific aggregation preference parameter.

10. The method of claim 8, wherein the general domain-ranking parameter is based on a user-specific general ranking attribute.

11. The method of claim 8, wherein the vertical domain-ranking parameter is based on a user-specific vertical ranking attribute.

12. The method of claim 10, wherein any one of the user-specific general ranking attribute and the user-specific vertical ranking attribute is based on the same at least one feature of the user's search history on which the user-specific aggregation parameter is based.

13. The method of claim 10, wherein any one of the user-specific general ranking attribute and the user-specific vertical ranking attribute is based on a second at least one feature of the user's search history, said second at least one feature of the user's search history being different from the at least one feature of the user's search history on which the user-specific aggregation parameter is based.

14. The method of claim 1, wherein the at least one feature of the user's search history includes at least one of user's past preference for aggregated general content and vertical content, general content alone, or vertical content alone; user's past preference for obtaining results from a specific vertical domain; and user's intent for the search query.

15. The method of claim 1, wherein the at least one feature of the user's search history includes at least one of a click-through rate; a number of times a search result item was selected or clicked within a particular time period; a dwell-time after clicking; and whether a click on a result item was the last user action in a previous user session.

16. The method of claim 14, wherein user's intent includes intent for a particular type of vertical content.

17. The method of claim 16, wherein the particular type of vertical content is video content, image content, commerce content, music content, weather content, geographic content, text content, dictionary content, events content, news content, or advertising content.

18. The method of claim 1, wherein the at least one feature of the user's search history includes any one of query data; vertical data; web data; and search-log data.

19. The method of claim 1, wherein the at least one feature of the user's search history includes any one of aggregated search need; certain vertical preference; and vertical navigationality.

20. The method of claim 1, wherein the user-specific aggregation preference parameter has been generated using a Gradient Boosted Decision Tree-based algorithm.

21. The method of claim 1, wherein the user-specific aggregation preference parameter has been generated using a machine learning algorithm.

22. The method of claim 1, wherein said user-specific aggregation preference parameter has been generated prior to a point of time when the user has submitted the search query.

23. The method of claim 22, wherein said appreciating step comprises retrieving the previously generated user-specific aggregation preference parameter.

24. The method of claim 1, wherein said user-specific aggregation preference parameter has been generated at a point of time when the user submitted the search query.

25. The method of claim 1, wherein said user-specific aggregation preference parameter has been generated after a point of time when the user submitted the search query.

26. The method of claim 1, wherein said generating said user-specific aggregation preference parameter comprises accessing a log, said log including at least one feature of the user's search history.

27. The method of claim 26, wherein said log is stored in association with the user's log-in credentials.

28. The method of claim 2, wherein the first vertical search result item is generated by searching a first vertical domain, the second vertical search result item is generated by searching a second vertical domain, and the first vertical domain and the second vertical domain are not the same.

29. The method of claim 2, wherein the first vertical search result item is generated by searching a first vertical domain, the second vertical search result item is generated by searching a second vertical domain, and the first vertical domain and the second vertical domain are the same.

30. The method of claim 1, further comprising a step of determining that the first general search result item and the first vertical search result item are relevant to the search query, prior to said ranking.

31. The method of claim 1, wherein the first general search result item is one of a plurality of general search result items having been ranked according to a general search result ranking and the first vertical search result item is one of a plurality of vertical search result items having been ranked according to a vertical search result ranking.

32. A server configured for presenting a search result page (SERP) to a user in response to a search query, the server having a non-transient computer usable information storage medium that stores computer executable instructions, which instructions when executed are configured to render the server operable to execute the steps of:
appreciating a user-specific aggregation preference parameter, the user-specific aggregation preference parameter having been generated based on at least one feature of the user's search history;
aggregating the first general search result item and the first vertical search result item into an aggregated set of search results;
ranking the first general search result item and the first vertical search result item relative to each other within the aggregated set of search results based at least on the user-specific aggregation preference parameter, to generate a ranked order of search results items; and
causing an electronic device associated with the user to display the ranked order of search results items within the SERP.
